(19) United States
(12) Patent Application Publication
(10) Pub. No.: US 2002/0049717 A1
(43) Pub. Date: Apr. 25, 2002

(54) Digital content distribution system and method

(76) Inventors: Michael D. Routtenberg, Surrey (CA); Clive D. Wrigley, West Vancouver (CA); Michael G. Beniston, Surrey (CA)

Correspondence Address: DORSEY & WHITNEY LLP, SUITE 3400, 1420 FIFTH AVENUE, SEATTLE, WA, 98101, US

(21) Appl. No.: 09/853,836

(22) Filed: May 10, 2001

Related U.S. Application Data
(60) Provisional application No. 60/203,318, filed on May 10, 2000.

(51) Int. Cl. G06F 7/00

(52) U.S. Cl. 707/1

(57) ABSTRACT

A method of distributing content files over a computer network includes encoding demonstration versions of identified files including an identification parameter associated with a user content storage device. Each file further includes demonstration parameters and purchase or rental pricing information. The files are transferred to the storage device. The user selects a file utilizing a player coupled to the storage device and the identification parameter is examined. When access is unexpired the file is decoded and purchase or rental pricing displayed. While the file is being accessed, it is determined whether the user has selected for purchase or rental, rejected, or not selected the file. In response to the purchase/rental selections, the user is provided temporary access to the files. Upon verifying charge to the user, the storage device is provide unlimited access in the case of purchase and limited access in the case of rental to the files.

### CROSS-REFERENCE TO RELATED APPLICATION

This application claims the benefit of U.S. provisional application No. 60/203,318, which was filed May 10, 2000.

### TECHNICAL FIELD

The present invention relates generally to the distribution of digital content, such as audio, video, and other data files, and more particularly to computer systems for distributing digital content.

### BACKGROUND OF THE INVENTION

Music distribution is being reshaped by three emerging technologies: Internet Audio; Satellite Radio; and Digital Audio Broadcasting. “Internet audio,” in general, does not refer to web sites that sell CDs online, but rather to the downloading of digitally recorded music files via the Internet, thereby allowing users to play music on their computer and, with a CD writer, to make their own music CDs. High quality digital audio files tend to be very large unless they are compressed. The most popular form of compressed music formats is known as MPEG Layer 3 audio, abbreviated to MP3. MP3 was developed in 1989 by Karlheinz Brandenburg, at Fraunhofer IIS, a German commercial research institute. MP3, standardized by the Motion Pictures Expert Group (MPEG) in 1991, constituted the third and most advanced method for compressing audio. The MP3 algorithm was so complicated that, in 1991, it could only run on very expensive dedicated pieces of hardware. However, the rapid evolution of computer technology was such that by 1996, with the Pentium 120, a standard PC could do the job. Also, in late 1996 the developers of the MP3 encoder and decoder software released the programs as shareware on the Internet. This combination of factors coupled with the rapid spread of information made possible by the Internet, created a strong following of MP3 “early adopters” by 1997.

In general, the trading of music over the Internet, using MP3 and other compressed audio formats, amounted to the widespread unauthorized copying and distribution of copyrighted music material. As such, it was viewed as a threat by the recording industry. In early 1997, due to pressure from the Recording Industry Association of America (RIAA), virtually all of the popular MP3 sites on the Net were forced to shut down. In early 1998, MP3 websites re-emerged, focusing less on the specific distribution of MP3s and more on MP3 resources—how to make MP3 files and where to get the latest players. MP3.COM was established as a portal in late 1998. Further, many programmers began to study the MP3 programs and improve upon them. This included the development of a low-level MP3 engine that could be easily integrated with separately developed software players having attractive user interfaces. One such interface, called WinAMP, provided a straightforward and attractive interface and quickly gained a massive following.

Despite resistance from the RIAA, by 1999, the MP3 standard became widely adopted by consumer electronics manufacturers and e-commerce companies. Dozens of consumer electronics makers, including RCA, Diamond Multimedia and Creative Labs, Sony, Panasonic, Toshiba, and Casio began developing solid state portable MP3 players and MP3.com went public in 1999. WinAMP's parent company, Nullsoft, was acquired by America Online and Yahoo! bought online audio/video giant broadcast.com. The RIAA, conceding that MP3 was becoming the de facto standard of digital music distribution, redirected their efforts from focusing exclusively on trying to stop the MP3 proliferation and began creating a new, secure music format. In late 1998, the RIAA joined forces with a broad spectrum of information technology and consumer electronics businesses to create the Secure Digital Music Initiative (SDMI). SMDI's mission is to create standards leading to Digital Music Access Technology (DMAT). DMAT technology, encompassing both hardware and software, will allow music to be distributed over the Internet, using such formats as MP3, while building in safeguards against unauthorized copying and distribution.

SMDI systems will enable consumers to easily collect and play music purchased from a variety of sources both on-line and off-line. Future specifications will address PCs, portable devices and car stereos. The long term specification, which will address the entire delivery chain, is targeted for initial public review in the second quarter of 2000. SMDI is open to companies that have significant direct activity in digital music or digital music technology. These companies must express their commitment to SMDI by agreeing to abide by its Terms of Participation and paying an annual membership fee (presently $20,000).

Currently, Internet audio content is available from a combination of authorized and unauthorized web based distribution sites. Authorized distribution sites include Musicmaker.com (NASDAQ: HITS), Emusic.com (NASDAQ: EMUS), and Liquid Audio. Unauthorized distribution sites include, MP3.com, which was charged with copyright infringement in April 2000.

Internet Audio player technology is developing rapidly on a number of fronts. By late 1999, with the increases both in processor speed and hard drive capacity, commercially available home computers had the capacity to store and play over 200 hours of MP3 encoded digital audio. Furthermore, the proliferation of broadband Internet access allowed music libraries of this size to be download, via the Internet, in a matter of just a few hours. Broadband Internet access—such as cable modems and high speed subscriber lines—will double to about 3 million by the end of 2000. Internet Radio with Thousands of Stations. In 1999, Silicon Valley TuneTo.com, established an Internet radio broadcasting site capable of delivering millions of near CD quality music channels. TuneTo.com has developed proprietary MP3 based streaming and caching technology that some experts regard as a low-cost competitor to offerings from RealNetworks and Microsoft. The service is free to consumers, who access the network by downloading, and installing on their PC, the company's proprietary software Internet radio tuner. Although TuneTo.com does not personalize stations, it does offer community based channels that match a listener's preferences with other listeners globally. The result is an easy to use system that links listeners to a wide selection of channels featuring a mix of songs they like. The listener clicks on his favorite artists to select the channels, and is able to rate every song in real time. TuneTo.com's automated program director works around the clock to refine the listener's channels. TuneTo.com is BMI, ASCAP and SESAC licensed and is authorized to webcast any and all commercially available recordings. The company has registered with the US Copyright office for digital transmission of music over the Internet in compliance with the Digital Millenium Copyright act.

In December 1999, Emusic.com Inc., and HanGo Electronics announced the Personal Jukebox PJB-100 portable music device. The PJB 100, which weighs 9.9 ounces, stores up to 81 hours of MP3 encoded digital music on a 4.86 GB, 2.5 inch internal hard drive. Music is loaded into the device via the users' PC. In early 2000, Sony introduced its Memory Stick Walkman portable music device. The 2.5 ounce device has no moving parts and stores up to two hours of music, in compressed form, on a 64 MB memory stick. The device transfers CD recordings and Internet downloads to and from a PC. It supports the MP3 compression, with the ability to upgrade to newer formats as they become available. In April, 2000, Virgin Mobile announced a hybrid device including an integrated MP3 player and mobile phone to be released by the summer of 2000. The phone, made by Samsung, will be able to download up to an album's worth of music from the Internet or CDs. The phone has 32 megabytes of memory and can transfer a three-minute track from computer to phone in about 30 seconds. Virgin Chairman Richard Branson said “We have plans to let people buy music and have it downloaded straight to their phone in our stores. And in the future it will be possible to buy and download music over the air, using the mobile network itself.”

In a classic game of cat and mouse, the technology of music piracy, now developing at Internet speed, continues to remain a step ahead of the industry and regulators. Napster, released in 1999, and Gnutella, released in March 2000, have achieved particular infamy for there sheer effectiveness at letting users exchange copyrighted music for free. In August of 1999, a 19 year old student released Napster, an innovative scheme to circumvent the RIAA's ability to enforce copyright protection. In 1997, the RIAA had been successful in forcing MP3 distribution sites to shut down because they were centralized servers that illegally distributed copyrighted material. However, Napster, allows online users to easily and efficiently search each others' computers for music stored in the MP3 format. The Napster server acts merely as a central database registry and does not itself distribute MP3 files. Napster argues that it has a legal right to operate in this manner based upon the so-called safe harbor provisions of the Digital Millennium Copyright Act (DMCA). The DMCA, passed in 1998, was at the time considered an important legislative battle for the entertainment industry. However, the new law has an important caveat, in that it also shields net access providers from liability, by placing the copyright burden on the person using a legitimate service. In other words, much as Xerox can't be held liable for the actions of people who copy books, songs and artwork on its machines, online service providers can't be held liable for the actions of their customers. In December 1999, the RIAA sued Napster for trafficking in piracy, seeking up to $100,000 in damages for each copyright-protected song allegedly exchanged illegally using the company's software. A San Francisco judge will soon rule on the lawsuit, which if successful, would put Napster out of business.

But the Napster case may be only the opening sword fight in an all out war between the RIAA and newer software that makes it virtually impossible to protect music, software programs, photographs, videos, or almost any other copyrighted digital material. Gnutella, unleashed in March 2000, is a subversive program that anyone can get for free from the Internet and install in minutes. Gnutella was developed by rogue programmers at Nullsoft, a subsidiary of America Online, who briefly posted the program on its web site on Mar. 14, 2000. It was yanked off the site within hours, but by then numerous copies had already popped up on other Web sites. More permutations of Gnutella appear daily. Gnutella is much more pernicious than Napster because it operates peer-to-peer, so there's no central site for investigators to target. When a user goes online and opens Gnutella, the program finds hosts, or other computers on the Internet running Gnutella. Gnutella is a vast and ever changing network of people. Like its namesake, the chocolate and hazelnut spread Nutella, it spreads fast and easy. Once a search request encounters another online Gnutella user, the application automatically tries to connect to every Gnutella user the first one has ever reached, making potentially thousands of direct simultaneous connections to personal computers.

Historically, industry and regulators inevitably adapt to new technology and its corresponding new threats. Ironically, once the adaptation is complete, industry most often becomes dependent on the large additional revenue streams generated by the very technology it once sought to suppress. VCRs are a case in point. In a landmark 1984 case, the motion picture industry lost its appeal to the U.S. Supreme Court to block sales of VCRs. Today, the purchase of movie videotapes by consumers has become one of the main sources of revenue for the film industry, while movie attendance has also soared. Indeed, the recording industry has created many of its own problems by developing its digital media strategies based on fears of intellectual property theft, rather than on the vast opportunities offered by the new medium. Jonathan Band, an attorney with the law firm Morrison & Foerster in Washington D.C. says “All the new software could have been developed by the record companies. But what you see is the industry trying to preserve the old model as opposed to taking advantage of the new model and being innovative and cutting edge. Despite the threats of music piracy, the market for recorded music, measured by what manufacturers ship to retail and non-retail channels, continued its upward trend, closing in on $15 billion. Sales of CD unit shipments grew by 11% between 1998 and 1999. Further, entertainment companies are winning new tools to enlist the courts as a major line of defense against copyright violators. While it will never be possible to arrest a million people, making examples of a few consumer copyright offenders can go a long way to discouraging wide spread infringement.

Another digital medium is Satellite Radio, which may be classified as fixed or mobile. Fixed satellite radio, offered by such companies as Direct TV, currently provides up to 50 channels of commercial free digital music broadcasts. Each of these channels is organized by musical category such as New Pop Releases, Classic Rock, Solid Gold Oldies, etc. These digital radio channels are available to Direct TV subscribers. In order to receive the signal, the subscriber must permanently mount an 18″ diameter satellite dish to a building exterior, such that the it points directly towards the broadcasting satellite, which is located in geo-synchronous orbit. Mobile satellite radio is the emerging satellite-to-car broadcasting industry that will be available to consumers beginning in 2001. It utilizes satellites placed in geo-synchronous orbits to broadcast up to 100 channels of CD quality digital audio directly to moving vehicles. In the U.S., the FCC licensed two companies to deliver the service: New York based Sirius Satellite Radio (“Sirius”); and Washington D.C. based XM Satellite Radio (“XM”), both of which are now publicly listed.

Each of the contenders will offer subscription based nationwide broadcasts of up to 100 compact disc quality commercial-free and non commercial-free channels which vehicles will receive via miniaturized satellite dishes. The dishes will be approximately 2 inches in diameter and ⅛ inch thick (approximately the size and shape of a silver dollar). Channels will consist of all-music all-news, all-sports, and all-talk programming. The companies anticipate that they will offer the service to subscribers for a monthly subscription fee of $9.95, which would entitle the subscriber to receive all channels broadcast over the new Satellite Radio band, the S-band. The potential market for Satellite Radio includes the owners of approximately 192 million motor vehicles expected to be registered in the United States in 1999, rising to approximately 200 million vehicles by 2004. Other potential markets include owners of portable, walkman, and home radios. If analysts are right, as many as 50 million people—most of them commuters, RV owners, and truckers—could sign up for these services by 2008.

Broadcasting industry sources indicate that American adults listen to an average of three hours of radio per day. In addition, such sources estimate that automobile commuters spend 97% of their drive time listening to the radio. Music programming dominates the radio airwaves, with FM radio stations exceeding AM stations in listenership. According to broadcasting industry sources, FM stations account for almost 80% of total radio listening. FM stations primarily concentrate on music programming, while AM stations have an increased proportion of their programming devoted to talk and news.

In order to receive Satellite Radio, subscribers will need satellite band radios. This means satellite radios will need to be installed in vehicles on an after market basis or factory installed in new vehicles. According to industry sources, U.S. consumers install 5 million AM/FM radios on an after market basis. Additionally, automotive industry sources report that over 14 million new cars and light trucks are sold in the United States annually, almost all of which contained radios. The Satellite radios will be similar in size and appearance to today's AM/FM car radios, and will include the AM/FM bands, as well as the S-band. In addition, the radios will feature a digital display capable of showing the Satellite Radio channel number, music format, song, title, recording artist and album title. The radios are expected to cost $125 more than typical car radios.

Sirius has exclusive alliances to factory-install Sirius receivers in Daimler Chrysler cars and light trucks, including Chrysler, Dodge, Jeep, Mercedes and is the preferred service provider for Freightliner and Sterling heavy trucks. Sirius also has exclusive alliances to factory install Sirius receivers in BMW, Ford, Jaguar, Mazda and Volvo automobiles. Sirius also has alliances with leading automotive electronics manufacturers to design and develop receivers for the automotive after market and for installation in new cars. These companies include Alpine, Clarion, Delphi Delco Electronics, Kenwood, Panasonic, Recoton, Sanyo and Visteon. Sirius has backing from the likes of Loral, Ford, financier Sid Bass, and Apollo Investments. XM is backed by General Motors, its DirectTV subsidiary, and radio giant Clear Channel Communications. Together the two companies have raised nearly $2 billion.

Beyond the challenge of getting satellites into orbit, scheduled for completion by early 2001, both companies face competitive, regulatory, and technical hurdles that could foul their plans. And even if their launches go smoothly, growth could be curbed by new rivals offering other alternatives such as wireless Web radio. Perhaps the biggest problem is that Sirius and XM Satellite Radio may not be true satellite services after all. For all their advances, the satellites they aim to launch can't deliver a perfect, continuous stream of music to mobile listeners from coast to coast. Unlike satellite-TV services such as DirectTV and EchoStar Communications Corp., satellite radio beams its signals to moving receivers, so reception is often disrupted by mountains, buildings, and even trucks moving alongside cars. So XM plans to build as many as 1,700 transmitters in urban markets, and Sirius, whose satellites will perch higher in the sky, plans to build 110. The risk is that even these repeater networks could fail to provide the seamless service that subscribers will demand. “If they don't have enough repeaters for quality service, they'll be out of business”, says Michael Alpert, president of Alpert & Associates in Washington, a satellite consultancy. To make matters worse, regular terrestrial radio—which has boomed in the past several years thanks to the advertising bonanza—also is in the midst of a slow transition to digital transmission. So satellite services could loose their competitive edge in sound quality.

Then there's regulatory static. For Sirius and XM to start on time, they'll need a nod from the Federal Communications Commission, which wants the two to develop a receiver that will work for both and not lock consumers into one service. But the two operators hope to wait a few years before designing a common receiver to keep hardware costs down and avoid a competitive free for all.

In-Band On-Channel Digital Audio Broadcast (IBOC DAB) technology, also referred to as iDAB™, is currently being designed and developed by USA Digital Radio. Owners of USA Digital Radio include thirteen of the largest radio broadcasters in the U.S., and other prominent media and investment companies. The organization's mission is to convert today's analogue AM and FM radio broadcasting to an all digital format, utilizing the iDAB technology. iDAB provides for enhanced sound fidelity, improved reception, and new data services. With iDAB, AM will sound like FM does today and FM will have compact-disc-like audio quality. Multipath, noise and interference, which cause the static, hiss and pops heard on today's analog radios will be virtually eliminated with iDAB, thus ensuring near-perfect reception. Additionally, iDAB will allow for new data services to be delivered from AM and FM radio stations, like station information, artist and song identification, scrolling of traffic, weather, news and sports scores, and other advanced services like downloadable music, email and Internet access. New digital radios will be affordable to consumers, eventually being sold for a small premium over existing analog radios

Little or no change in consumer behavior will be required since all local radio station dial positions will remain the same. Consumers will simply tune to their favorite programs and stations and receive them in either a digital or analog format depending on their radio. iDAB makes use of the existing AM and FM band (In-Band) by adding digital carriers to a radio station's analog signal, allowing broadcasters to transmit digitally on their existing channel assignments (On-Channel). A station will convert to iDAB and begin transmitting a simultaneous analog and digital signal, known as the “Hybrid Mode”. iDAB radios will be backward and forward compatible allowing them to receive traditional analog broadcasts from stations that have yet to convert and digital broadcasts from stations that have converted. Current analog radios will continue to receive the analog portion of the broadcast, allowing for a smooth transition to a digital world over many years.

When a significant majority of broadcasters and consumers have converted to digital, the FCC will evaluate when to transition to the “All-Digital Mode”. In this mode, broadcasters will transition out of analog broadcasts and offer all-digital broadcasts. As a result of the additional data capacity associated with an all-digital broadcast, enhanced services will become available.

There is a need for a digital content distribution system that allows digital content to be distributed using relatively new technologies such as the Internet while providing copyright owners and content distributors with protection against widespread unauthorized copying and providing the ability to collect fees for distributed content.

### SUMMARY OF THE INVENTION

According to one aspect of the present invention, a method of distributing digital content files to a user content storage device over a computer network includes identifying content files to be distributed to the user and encoding demonstration versions of the identified content files. The encoding includes an identification parameter associated with the user's content storage device, and each demonstration version further including demonstration parameters and purchase or rental pricing information. The encoded demonstration versions of the content files are transferred to the user's content storage device. In response to the user selecting a transferred encoded demonstration version of a respective content file by utilizing a player that is contained in or coupled to the content storage device, the identification parameter is examined to determine whether access to the selected encoded content file is unexpired. When access is unexpired, the content file is decoded for use and review by the user and displaying purchase pricing or rental information. While the content of the file is being accessed via the player, it is determined whether the user has selected for purchase or rental, rejected, or not selected the corresponding content file. In response to the respective selections for purchase or rental user determinations for the content files, the user is provided temporary access to the decoded selected files. Upon verifying charge to the user, the content storage device is provide unlimited access in the case of purchase and limited access in the case of rental to the content files using the player.

According to another aspect of the present invention, a system and method deliver customized secured digital audio content to fixed, mobile, portable or transportable digital audio players. The system employs a digital audio portal that receives digital audio streams (including, but not limited to music) from a variety of delivery mediums including satellite, Internet, and cable. The portal, which employs preference filters specified by the user, automatically compiles digital audio (music and other) content, and associated databases, which is customized to the tastes of each listener. Operating in such manner, the portal essentially functions as a personal disk jockey. Once having completed such custom digital audio track compilation, typically containing over 100 hours of fresh content, the portal delivers the tracks and associated database to a fixed, mobile, portable or transportable digital audio player. Delivery is achieved via a fixed or wireless data connection.

The player, utilizing the database, allows the listener to access the full audio track compilation by title, artist, album or music category. Each audio track may be played on a demonstration basis, any number of times, for a limited duration (24 hours for example). Alternatively, the player allows the listener, at the touch of a button, to purchase any particular demonstration audio track while it is playing. Purchased audio tracks are written once to a removable digital storage medium built into the player. The player and portal work in conjunction with a digital audio distribution hub to bill the user's account for purchased audio content and, optionally, deliver higher quality (for example, less compressed) versions of digital audio tracks to the player, once those tracks have been purchased. In one embodiment, the digital audio player resides in a vehicle, such as a privately owned car. When the vehicle is parked proximate the portal (in the user's driveway, for example), the portal automatically updates the player with fresh audio content.

### BRIEF DESCRIPTION OF THE DRAWINGS

FIG. 1 is a block diagram illustrating a computer content distribution system according to one embodiment of the present invention.

FIG. 2 is a block diagram of a digital audio distribution system including a digital audio player contained in a vehicle according to one embodiment of the present invention.

FIG. 3 illustrates a sample Web-based music selection screen displayed on the digital audio portal of FIG. 2 when a subscriber operating the digital audio portal accesses the digital audio distribution hub of FIG. 2 via the Internet and supplies valid account and password information.

FIG. 4 depicts the wireless data exchange between the digital audio portal and digital audio player of FIG. 2.

FIG. 5 illustrates one embodiment of an operator interface portion or console of the digital audio player of FIG. 2 and illustrates operation of the player.

FIG. 6 is a more detailed functional block diagram illustrating the digital audio player of FIG. 2 according to one embodiment of the present invention.

FIG. 7 is a more detailed functional block diagram illustrating the digital audio portal of FIG. 2 according to one embodiment of the present invention.

FIG. 8 is a diagram illustrating one embodiment of an encrypted database record and various fields of the record, which is downloaded along with each selected audio file from the digital audio distribution hub to the digital audio portal and then to the digital audio player, all of which are shown in FIG. 2.

### DETAILED DESCRIPTION OF THE INVENTION

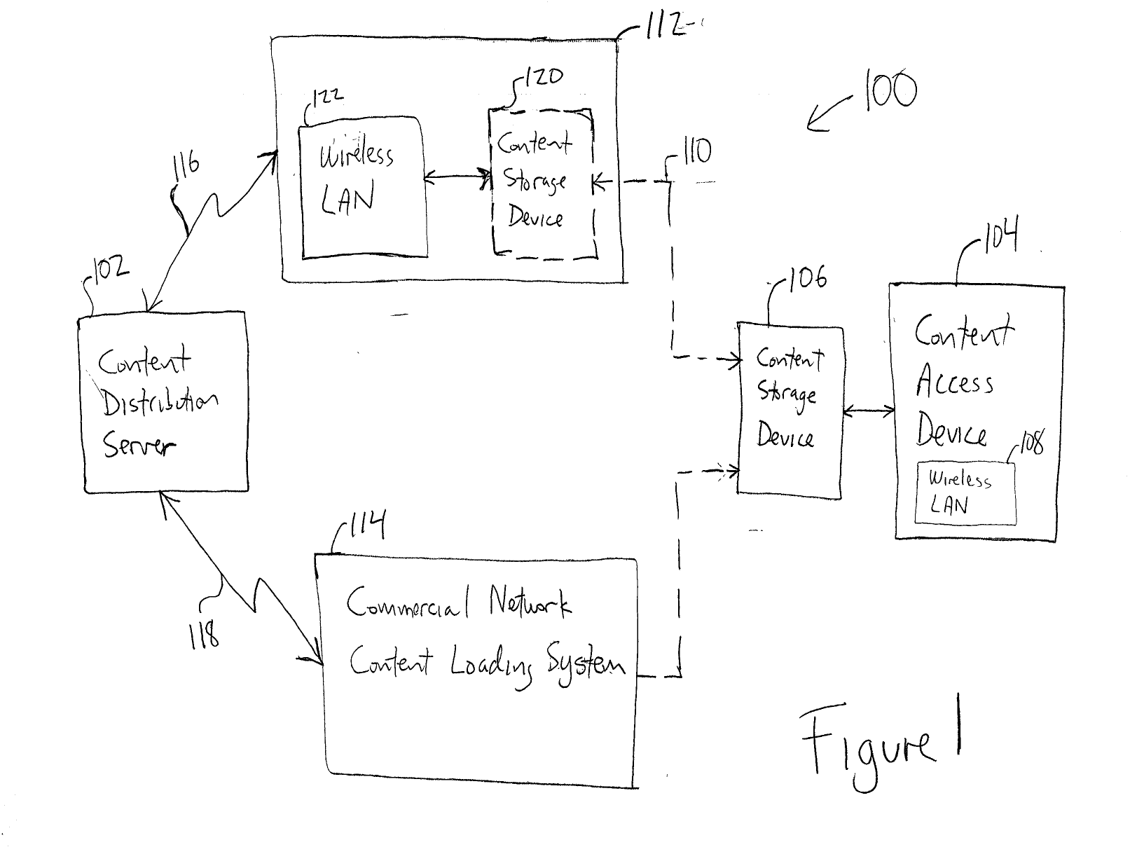

FIG. 1 is a block diagram of a digital content distribution system 100 including a content distribution server 102 that transfers selected digital content files to a content storage device 106 that is coupled to a content access device 104 which, in turn, allows a user to access the transferred files and determine whether to purchase, rent, or reject the selected content files, as will be explained in more detail below. Briefly, the transferred files are encoded at three different levels: 1) the files are encoded so that they can be accessed only on an individual or specified group of content access devices 104; 2) the files are encoded with specific demonstration parameters that define the type restricted access provided to the user, such as the user being able to access the files only a predetermined number of times or being able to access the files only for a limited duration; and 3) the files are encoded with pricing information so that pricing information may be displayed to the user while reviewing the file to allow the user to determine whether to purchase, rent, or reject the file. The user utilizes the content access device 104 to select particular content files stored on the content storage device 106, and while accessing the selected content file the user decides whether to purchase, rent, or reject the file. These purchase, rent, or reject determinations, along with information about content files stored on the content storage device 106 but not selected by the user, are thereafter communicated to the server 102 the next time the content storage device 106 is coupled to the server, as will be explained in more detail below. The content files may be any type of data files, such as audio, video, and text files, and may also be files containing other types of data such as navigational data. The system 100 may operate on different content type files simultaneously or on only a single file type, such as audio files when the system corresponds to an audio distribution system. In the following description, certain details are set forth to provide a sufficient understanding of the invention. However, it will be clear to one skilled in the art that the invention may be practiced without these particular details. In other instances, well-known circuits, control signals, timing protocols, and software operations have not been shown in detail in order to avoid unnecessarily obscuring the invention.

In FIG. 1, the content storage device 106 stores downloaded digital content files and may also include control software for encoding and decoding a downloaded selected digital content files and tracking files that are selected and non-selected by the user. The control software may, alternatively, be located on the content access device 104. The digital content files downloaded to the content storage device 106 are encoded so that the files can only be accessed on authorized content access devices 104. The term “encoded” as used herein includes specific coding formats for files, such as MP3 for audio files, and also includes security protocols such as encryption of the downloaded content files. In the embodiment of FIG. 1, the content storage device 106 may be a portable device that is adapted to be plugged into and removed from a storage device cradle (not shown) contained in the content access device 104. The content storage device 106 may alternately be permanently coupled to the content access device 104. The content access device 104 may take a variety of different forms, such as a portable device similar to a Sony Walkman type player or may be a personal-computer-based system in which the storage device 106 interfaces to the system via a universal serial bus port and the computer executes software to allow the user to access the content files. In another embodiment, the content access device 104 corresponds to a vehicle-based system physically located in a vehicle such as a car or truck. In this embodiment, a head unit (not shown) may be a conventional head unit that provides operator interface and is mounted, for example, in a dashboard of the vehicle, and the storage device 106 is coupled to a disk emulation device that emulates a CD-changer and allows an operator of the head unit to access selected tracks stored on the content storage device as if those tracks were stored on conventional compact discs. In one embodiment, the content storage device 106 is permanently coupled to the content access device 104, which includes a wireless LAN component 108 to transfer content files and related information to and from the content storage device, as will be explained in more detail below.

The content distribution system 100 further includes a consumer network content loading system 112 and a commercial network content loading system 114 that are alternately coupled to the content storage device 106 and provide communication between the storage device and the content distribution server 102 via respective communications links 116 and 118, which are typically networks including the Internet. Each of the content loading systems 112, 114 may take a variety of different forms. In the embodiment of FIG. 1, the content loading system 112 corresponds to a personal-computer-based system that would typically be located in the residence or workplace of the user. The system 112 includes a content storage device 120 that stores content files transferred from the server 102. Typically, the content storage device 120 corresponds to a hard disk in the system 112.

The system 112 includes a processor (not shown) that executes software that communicates with the content storage device 106, with such communications being, for example, over the universal serial bus of the system 112. The software also allows the user to access the server 102 to establish a user account and provide user profile information, and also allows the user to select desired content on the server and download the selected content to the content storage device 120. The software also includes a communications component that transfers selected content from the content storage device 120 to the content storage device 106, and receives from the content storage device 106 selected and nonselected information for previously downloaded content files, with this information then being communicated to the server 102 to allow the user to be billed for selected content files and to develop user profile information from the rejected and nonselected file information, as will be described in more detail below. The content storage device 106 may be physically connected to the system 112 to receive the downloaded content files, or such files my be transferred to the content storage device 106 via a wireless communications link 110 and a wireless LAN component 122 contained in the system 122. Typically, the communications link 116 is slow modem-based connection, or a relatively slow DSL or cable modem broadband connection, and thus the system 112 allows content files to be downloaded and “queued” on the content storage device 120 while the content storage device 106 is connected to the content access device 104. Without such a queue, the time to download large content files (e.g., video files) directly to the content storage device 106 may be undesirably long, even where the link 116 is a broadband DSL or cable modem type connection. Instead of a wireless link 110 between the content access device 104 and the content storage device 120, the content storage device 106 may be physically transported between the system 112 and the content access device 104.

The commercial network content loading system 114 corresponds to a commercial network port into which the content storage device 106 may be plugged and removed, and which provides high speed broadband access to the server 102 via the link 118. The commercial network port is located in a commercial setting, such as a gas station, library, or shopping mall. As will be appreciated by those skilled in the art, broadband access is provided in many commercial settings while not always available in residential settings. Moreover, the broadband link 118 is many times a high speed fiber optic link which is much faster than a residential broadband DSL or cable modem link 116. Thus, the communications link 118 provides high speed file transfer from the server 102 and thus allows even large digital content files and associated information to be more quickly communicated between the server and system 114. With the content loading system 114, the user will have previously accessed the server 102 and supplied user profile information so that when the content storage device 106 is plugged into the system 114, information regarding selected and nonselected content files is provided to the server and billing verification communicated from the server to the system 114. Moreover, while the content storage device 106 is connected to the system 114 new content files identified by the server using the user profile are downloaded to the content storage device.

In operation of the content distribution system 100, a user first establishes an account with the distributor of the content by accessing the server 102, providing credit and billing information, and supplying user profile information to allow the system to recommend content to the user in the future. Along with providing this initial user information, the user also purchases or is provided with the content storage device 106. The user then selects desired digital content files contained on the content distribution server 102, and in response to the user selections, the server 102 encodes the selected content files and downloads the files to the user's content storage device 106. As previously mentioned, the files are encoded so that the user can only access the files on predetermined content access devices 104, the user has only limited access to the downloaded content files such as through limited number of times each file can be reviewed or only allowing access for a limited duration. In this way, the distributor of the digital content files need not be concerned about the user copying or distributing unauthorized copies of the downloaded content files. Recall, when the user accesses the server 102 via the system 114 the content files are directly transferred to the content storage device 106, and when the user accesses the server via the system 112, the files are typically transferred to the content storage device 120 and then transferred to the content storage device 106 via the wireless link 110, wireless LAN 108, and content access device 104.

Once the content files have been transferred to the content storage device 106, the user plugs the content storage device 106 into the content access device 104 and selects particular downloaded content file to review. For each downloaded file, one of the demonstration parameters includes an expiration parameter that defines how long a user may review the downloaded files. This parameter ensures content files downloaded by the user but not selected may only be previewed for a limited time. Because the capacity of the content storage device 106 allows, for example, thousands of CD quality songs to be stored on the device, most of such files will not be reviewed by the user and this parameter allows such files to be removed from the storage device 106. While the user is reviewing the content of the file, the content access device 104 displays pricing information to the user to allow the user to determine whether to purchase, rent, or reject the selected file. When the user makes this determination, the user supplies appropriate input to the content access device 104 and this input for each selected content file is then stored on the content storage device 106. The user proceeds in this manner for any number of downloaded content files that the user desires to select, with each selected file then being either purchased, rented, or rejected by the user. As used herein, the terms “purchase” and “rent” are used broadly and include other types of property interests the user my obtain in the files.

Once the user has reviewed and made his selection decisions on particular files, the user is provided temporary access to the selected files that he has decided to either purchase or rent. This temporary access provides the user limited access to the files, such as providing access for a limited demonstration time or a limited number of demonstration accesses. The user must thereafter once again couple the content storage device 106 to either the content loading system 112, which may be via wireless link or direct physical connection, or to the content loading system 114 to finalize the purchase of the selected content files. When the content storage device 106 is plugged into the system 112 or 114, purchase, rental, rejection, and nonselection information is communicated through the respective content loading system 112, 114 to the server 102 which, in turn, bills the user for the purchased and rented content files and utilizes the purchase, rental, rejection and nonselection information to update the user's profile. At this point, if the server 102 was successful in billing the user for the purchased and rented content files, the server 102 communicates this fact through the corresponding content loading system 112, 114 to the content storage device 106, which thereafter provides the user with unlimited access to purchased content files and provides the user with limited access to rented content files. Once again, the limitations on the rented files may limit the number of times the user may access the files or the duration for which the user may access the files.

Note that even where the user's access to purchased content files is unlimited once the user has been successfully billed, the user can only access such files using the content storage device 106 and predefined access devices 104. This prevents the user from making and distributing unauthorized copies of selected digital content files. Various encryption technologies may be utilized to prevent the user from making unauthorized copies of the distributed digital content files. Such technologies are well understood by those skilled in the art, and thus, the sake of brevity, will not be described in more detail. For purchased and rented content files, the server 102 may at this time provide higher quality versions of the files to the content storage device 106. For example, when the purchased or rented content file is an audio file, the initial or demonstration version of the file reviewed by the user may be an MP3 file and after the user has made the purchase or rental determination and has been successfully billed for the file, the server 102 may downloaded a CD quality version of the file to the content storage device 106.

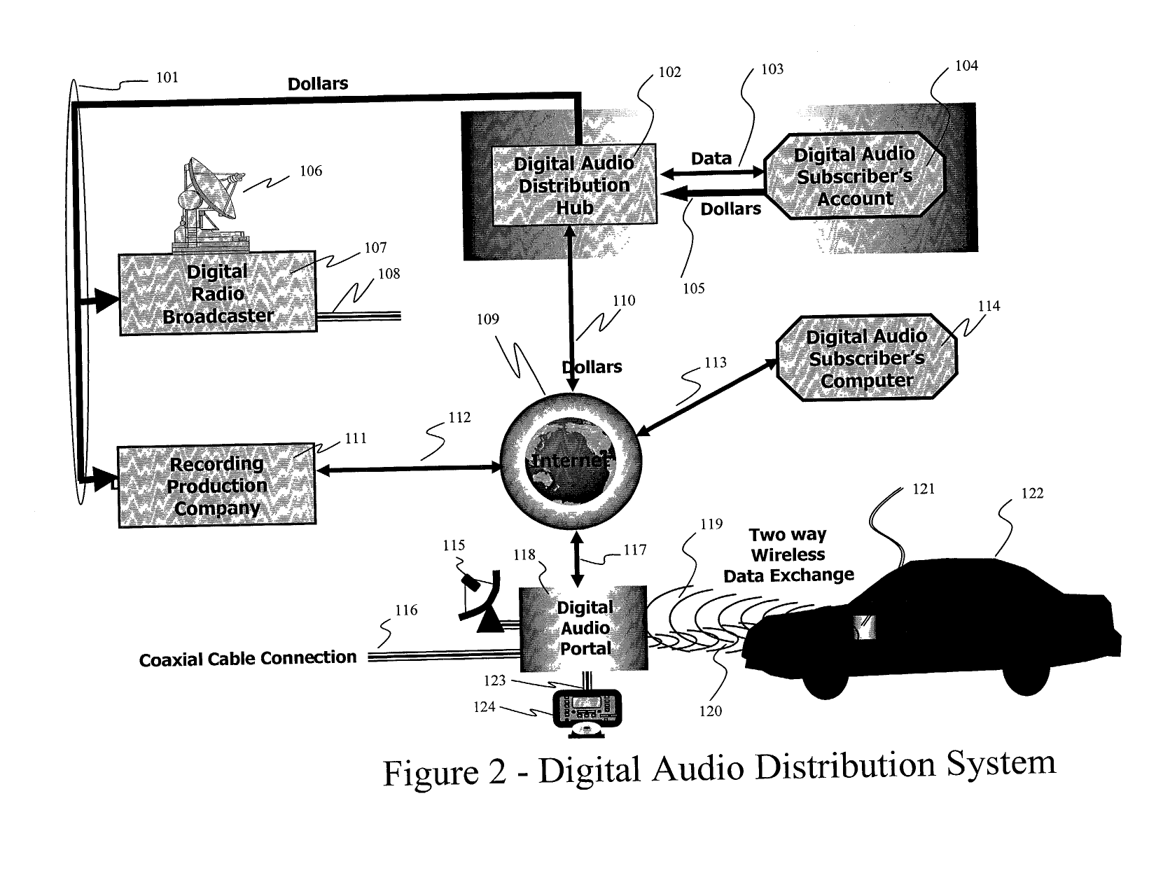

FIG. 2 is a block diagram of a Digital Audio Distribution System 200 including a Digital Audio Player (121) is installed within a vehicle (122) according to another embodiment of the present invention. The Player (121) receives, from a Portal (118), via a wireless or hard wired link (120), audio content (for example, music) data files and related audio track database files. The Portal receives, from the Player (121), via the wireless or hard wired link (119), listener preference files, which include track and album purchase requests and track delete requests as entered by the listener into the Player (121). The Portal (118) connects to the Internet via connection (117), which in one embodiment is a high bandwidth connection. The Portal (118) receives multiple pre-mixed digital radio channels from a Digital Radio Broadcaster (107), via satellite (115), cable (116) and /or other means including the terrestrial broadcast transmissions. The Digital Audio Distribution Hub (102) provides, or causes to be provided, additional audio content to the Portal (118) directly over the Internet (117) and also control the operation of the Portal (118). The Digital Audio Distribution Hub (102) typically includes one or multiple distributed computer facilities specifically established in connection with the Digital Audio Distribution System 200 disclosed herein. The Digital Radio Broadcaster (107) typically includes one or multiple broadcasters, as the case may be, and may include, but not be limited to, a satellite digital radio broadcaster (106). The Recording Production Company (111) typically includes multiple record production companies.

The Digital Audio Distribution Hub (102) administers a number of Digital Music subscribers' accounts (104) and provides settlement payments (101) to Digital Radio Broadcasters (107) for use of their broadcast content and to the Recording Production Company (111) for music that is downloaded to Players (121) and purchased by subscribers. The Digital Audio Distribution Hub (102) hosts Web pages used by subscribers for audio track selection, via the subscriber's computer or other Internet access device (114). The Digital Audio Distribution Hub (102) utilizes this information to update the Digital Audio Subscriber's Account (104) with listener preference data. The Digital Audio Distribution Hub (102) further refines each subscriber's listening preference data by uploading, from each Portal (118), via the Internet (110, 117) purchase requests and track delete requests entered by each listener into their Digital Audio Player (121).

Based upon this preference data, the Digital Audio Distribution Hub (102) delivers, or causes to be delivered, to the Portal (118), via the Internet connection (110, 117), specific audio tracks that the subscriber has requested to have delivered either for the purpose of demonstration or purchase. The Hub (102) also delivers, or causes to be delivered, files to the Portal (118), containing purchased audio tracks, which can be permanently copied onto a DSM, including CDs or DVDs. In cases where the Hub (102) causes specific audio tracks to be delivered to the Portal (118), such delivery mechanism may include the Hub (102) making a request via the Internet (110, 112) to a specific Recording Production Company (111) to deliver the requested audio track directly to the Portal (118) via the Internet (112, 117).

The Hub (102) utilizes listener preference data to create a customized audio track selection filter for each subscriber. This selection filter is downloaded, on a periodic basis, to each subscriber's Portal (118) via the Internet connections (110, 117). Collaborative filtering technology may be employed in the creation of such customized filters. The Digital Audio Distribution Hub (102) analyzes the music preference data in all subscribers' accounts (104) to compile, on a regular basis, demographic music preference and purchase statistics, which are delivered to Record Production Companies (111) via the Internet (110, 112). Finally, the Portal (118) also provides for a fixed data connection (123) to a Player (124) which may be installed as a component within the subscriber's home entertainment system.

The system 200 blends the best features of Internet audio, satellite radio and digital audio broadcasting, while eliminating many of the shortcomings of each medium. It combines the ease and convenience of satellite radio, the efficiency of digital audio broadcasting and the Internet's power to offer programming customized to each listener and to provide electronic delivery of purchased audio track content. The system 200 provides listeners with free and easy access to the audio tracks (including, but not limited to music tracks) of their choice while providing built in safeguards against piracy. The system 200 downloads, from digital radio broadcasters and from the Internet, potentially several thousand tracks of individually customized audio mixes to the portal (118) each day. The tracks are stored within the Digital Audio Player 124 and provides listeners with the option of listening to tracks on a free demonstration basis for a limited period of time, or purchasing tracks to add to their own permanent private music and audio collection. Individual tracks or complete albums are purchased from the Digital Audio Player 124 itself, at the touch of a button. The Digital Audio Player 124 permanently writes purchased tracks to a self-contained removable Digital Storage Medium (DSM), such as a CD or DVD, which, in one embodiment, is inter-operable with other digital audio devices—such as CD or DVD players. Further, both the player and the DSM are designed to comply with SMDI and DMAT security standards. In one embodiment, the Digital Audio Player 124 is installed within cars or trucks, because statistics show that drive time is one of the principle music listening periods and because vehicle installed units can be designed, with current technology, to store several hundred hours of music. However, the system 200 may also be adapted to apply to fixed, transportable, or portable Digital Audio Players.

To facilitate downloading of audio files, the Digital Audio Player 124 operates in conjunction with the portal 118, which is connected to the Internet. In one embodiment, such connection is a high bandwidth connection, including, but not limited to, coaxial cable, ADSL or CAT5 telephone line connection. Further, the Digital Audio Portal 118 receives via satellite, cable and/or antenna multiple digital music and other digital audio channels from digital radio broadcasters. In the one embodiment, the Portal 118 receives, via such mediums, a number of channels of narrow cast radio programming, such that each radio channel contains audio content within a specific category. Such categories could include specific music categories New Pop Releases, Classic Rock, Solid Gold Oldies, etc.

The Digital Audio Portal 118 functions as a personal disk jockey. Via the aforementioned multiple communication mediums, the Portal 118 continuously receives digital audio streams, which it filters to select those tracks that best match pre-set criteria determined by each listener. Such selection criteria is initially established by the subscriber through a password protected Web Site that allows users to select general audio content categories together with specific tracks, songs, albums and artists. In addition, the subscriber's track selection behavior, when using the Digital Audio Player 124, further refines the filtering criteria of the Portal 118. Music selected by the Portal 118 is stored in a digitally compressed format in the Portal's internal hard drive or in another high-capacity data storage medium.

The Digital Audio Portal 118 updates the Digital Audio Player 124 with new music and other audio tracks automatically via either a fixed or wireless connection. In the case of a wireless connection, such update occurs whenever the Player 124 is brought proximate (within 100 meters, for example) of the Portal 118. One current standard for wireless data transmission is the IEEE 802.11b specification, which provides wireless data transfer rates of up to 11 Mbs, or 81 MB per minute, over a distance of up to 100 meters without line of sight requirements. Since 1 hour of MP3 encoded music requires approximately 32 MB of data, the Digital Audio Portal 118 and Player 124 based on the IEEE 802.11b specification would download one hour of digital music in less than 30 seconds. A car installed Digital Audio Player 124 could therefore automatically receive, from the Portal 118, up to several hundred hours of fresh audio content each night while parked in the driveway or garage. Each 100 hours of MP3 encoded music (or other audio content), including associated data files, requires less than 4 GB of player memory. Such memory capacity is easily achievable and affordable with current disk drive technology. The concept of using vehicle idle time to distribute music is one way of distinguishing this invention from other forms of digital music distribution.

If selected and authorized by the subscriber, the system 200 may automatically build a database of listener preferences. Such database is compiled by tracking each subscriber's choice of pre-mixed audio channels and specifically requested audio tracks, as well as the specific tracks that are deleted, and purchased on the Digital Audio Player 124. It uses this information to build a listening preference profile for each user. In an embodiment, the system utilizes this listening preference profile to compile ever more appealing custom audio content and/or music mixes for each subscriber.

To prevent unauthorized use or copying of copyrighted material, the Digital Audio Player 124 and companion Digital Audio Portal 118 are fully compliant with both SMDI and DMAT and offer several built in security features. While SMDI and DMAT are designed to protect copyright holders from unauthorized use, its specification does not contain a number of commercial aspects addressed in this patent application. Specifically, this invention provides for the ability to distribute music and other audio track samples, as single tracks or albums, which may be listened to once, or any number of times, prior to a defined expiry date, before being either purchased or automatically deleted by the system.

In addition to using SMDI and DMAT the system 200 invention introduces several new steps for the protection and tracking the music distribution. First, encryption of all transmissions from Portal 118 to Player 124 with a key derived from a unique serial number associated with each Digital Audio Portal and Player system. The use of X.509 (or future derivatives) digital certificates or signed XML to authenticate the subscribers' Digital Audio Portal 118 to the Digital Audio Distribution Hub 112, and to authenticate the Digital Audio Player 124 to the Digital Audio Portal. An additional layer of encryption allows for more flexibility in the sampling or purchasing of music. For example, the Digital Audio Player 124 and Portal 118 may automatically erase, or make unavailable, all non-purchased demonstration audio tracks after a preset time period (e.g. 24 hours), which begins as soon as the track is first played. This is achieved through the use of digital certificates, which are created when the track is first played, and then expire after at a pre-set time interval. The Digital Audio Player 124 will not decrypt audio tracks with an expired certificate. The Digital Audio Player 124 performs periodic housekeeping to delete all tracks with expired certificates. The deliberate absence, both from the Player 124 and the Portal 118, of any digital data stream that can be used to capture music content, other than to the digital storage (DSM) writer. Each track that is purchased and copied to a DSM, contains a digital watermark, preventing it from being used to produce further unauthorized digital copies.

In addition to the rich entertainment value and convenience afforded to consumers, the Digital Audio Distribution System 200 is designed to provide substantial benefits to the recording industry. From the perspective of record companies, each Digital Audio Player 124 functions as a retail sales outlet for music and other audio content. Through such outlet, the likelihood of buying is increased by uninterrupted listening time; a music mix that has been individually “tuned” to the listener's tastes; and an extreme ease of purchase that facilitates impulse buying decisions. Further, the system 200 is capable of supplying record companies with real time information related to the music purchases and tastes of each listener, which can be analyzed demographically to rapidly identify and target emerging music trends and markets.

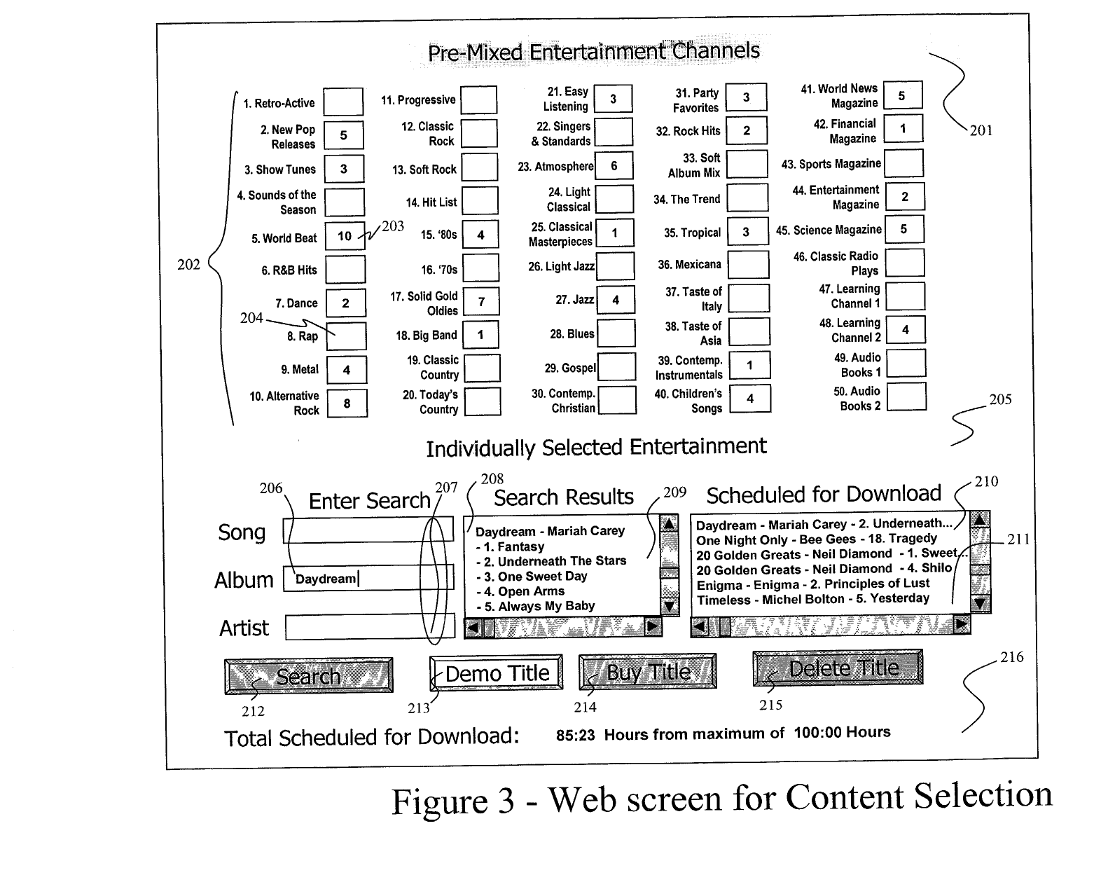

FIG. 3 provides a representation of the Web based music selection screen that the subscriber sees after connecting to the Digital Audio Distribution Hub (102) via the Internet (110, 113) and entering account and password information. Each subscriber is given an arbitrary preset daily quantity of “fresh” music and other audio tracks, which might typically range between 100 to 200 hours. Fresh audio content refers to all audio tracks that have not been accessed by a listener. Access is defined as either: playing the track (e.g. from start to finish); deleting the track; or purchasing the track. If, on a given day, a user's Digital Audio Player had been loaded with 100 hours of fresh audio tracks and only 10 hours were accessed, as defined above, then 90 hours of fresh audio tracks would remain. On the next day, the Portal would download just 10 hours of new audio to replace the “stale audio”. This minimizes data transfers, keeping bandwidth consumption and network congestion to a minimum.

In this example, as shown in the bar labeled “Total Scheduled for Download” (216) the subscriber has selected 85 hours, 23 minutes of audio tracks from a daily maximum of 100 hours. The subscriber has two options for selecting audio, which include Pre-Mixed Entertainment Channels (201) and Individually Selected Entertainment (205). FIG. 3 illustrates some examples of pre-mixed entertainment channels. The system and method disclosed in this invention provides for any number of channels, with each channel containing a designated class of entertainment. A designated class of entertainment consists of a particular category of music (exemplified by boxes 1 through 40), or a particular category with other specialized audio content (exemplified by boxes 41 through 50). The subscriber enters the number of hours of audio tracks to be downloaded from each channel, based on entertainment class preferences. In the example shown in this figure, the subscriber particularly liked Channel 5 (World Beat), and requested 10 hours of music (203) from this category. The user didn't like Channel 8 (Rap), and didn't request any music from this category (204). In one embodiment of this invention, music entertainment channels will all be commercial free. Other audio entertainment channels, such as news, could include commercial advertisements in the mix.

The Individually Selected Entertainment section (205) allows the subscriber to select a specific song, album or artist (207) and perform a search (212). In this example, the listener performed a search for the album “Daydream” (206). The search results appear in the next window (208), and list the album, artist and each track. The subscriber has the option of selecting the entire album, or specific tracks. In this example the user selected track number 2, “Underneath The Stars” (209). Once selected, the user chooses either to Demo Title (213) or Buy Title (214). In this example the user selected Demo Tile (213) and the song was added to the top of the list for tracks Scheduled for Download (210). Delete Title (215) allows the user to delete items Scheduled for Download (210).

The system maintains a log of all demo requests and ensures that any particular track may be specifically requested for demo no more than once. After that, the track will only be downloaded if purchased by clicking on Buy Title (214), or if randomly provided in one of the pre-mixed audio channels. If provided in the pre-mixed audio channel, the track may be purchased directly from the Digital Audio Player 124. In addition, the system may provide another individually selected entertainment screen for the purpose of allowing the user to choose specific non-musical audio content. This selection screen would operate in a manner similar to the music selection screen, but would allow the user to search by either criteria such as topic, program, lead commentator, author, etc. The system adds the time of each individually selected track or album to the total number of hours of pre-mixed audio channels to provide a running total, and will not allow requested downloads to exceed the maximum internal storage capacity of the Digital Audio Player 124 (100 hours in this example).

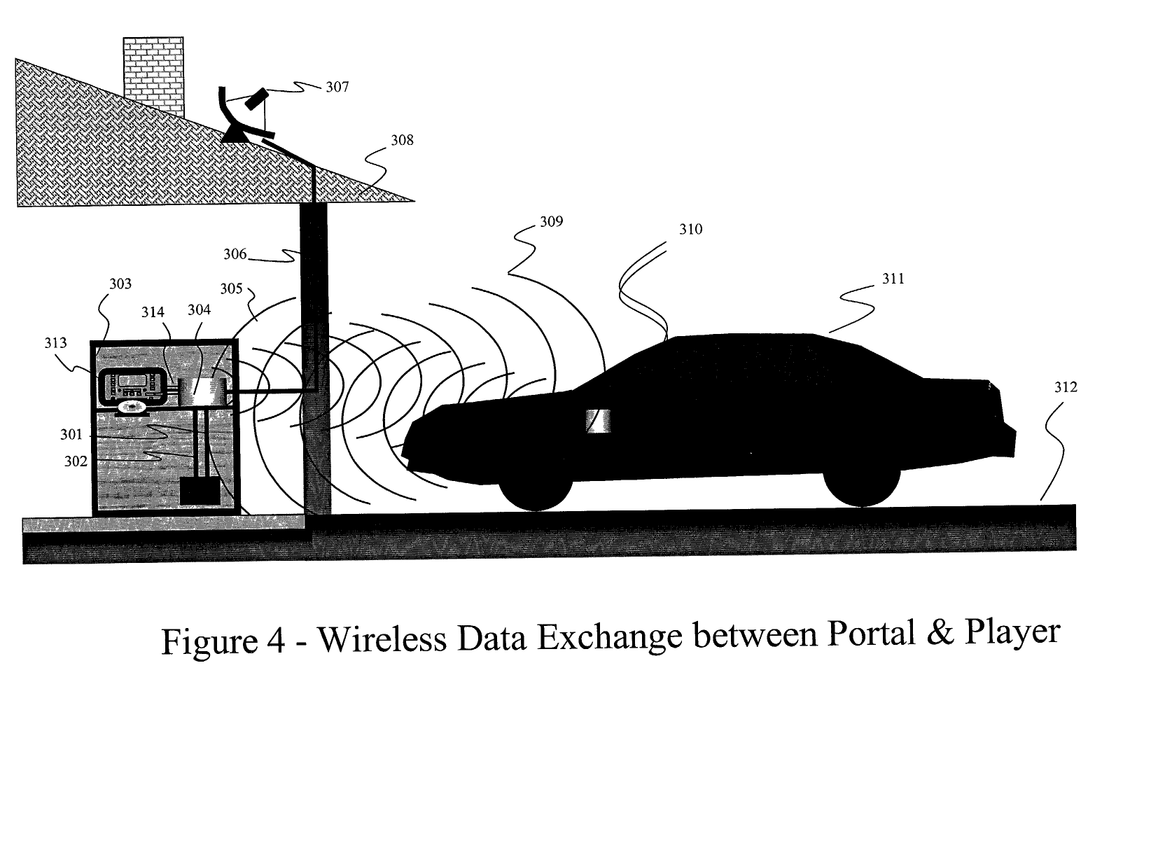

FIG. 4 depicts the wireless data exchange (305, 309) between the Digital Audio Portal (304) and Digital Audio Player (310) installed within the car (311). The Portal (304) and the Player (310) sense one another's presence and begin exchanging data automatically, whenever the car is parked. The first step in this process is for the Digital Audio Portal (304) and the Digital Audio Player (310) to establish authenticity of the other device. This may be achieved by exchanging signed XML or digital certificates. This exchange takes place in order to authenticate the subscriber to the Digital Audio Distribution Hub (102) and to establish a Secure Socket Layer (SSL) between the devices, which encrypts the communication channel. This prevents eavesdropping and hostile channel manipulation.

The wireless data exchange (305, 309) operates as a Wireless Local Area data Network (WLAN) in accordance with an established high bandwidth wireless communication standard. One such suitable standard is IEEE 802.11b. IEEE 802.11b is a current IEEE (Institute for Electrical & Electronic Engineers) ratified specification for wireless LANs. The 802.11b standard uses 2.4 GHz direct sequence spread spectrum radio technology and Ethernet-like protocols to provide up to 11 Mbs, 82 MB per minute, maximum data rate without line of sight requirements. Fallback data rates are 5.5 Mbps, 2 Mbps and 1 Mbps. Most 802.11b networks use an access point as a “wireless hub” which communicates with network interface cards in portable and desktop PCs. In a normal office-building environment, the network cards and access points can communicate up to 100 meters.

The IEEE 802.11b standard, because it has no line of sight requirements and a communications range of 100 meters, allows the Digital Audio Portal (304) to be located inside a home (308), within a subscriber's entertainment unit (303), affording physical protection and facilitating interconnection. In addition, the Portal (304) provides for an optional hard-wired or wireless connection (314) to another Digital Audio Player (313), which may be connected to the user's home stereo system. The Portal (304) provides an Internet connection (301), a coaxial cable connection (302), and a satellite connection (306, 307). Through some or all of these connections, the Portal (304) receives digital audio content. In an embodiment the Internet connection (301) is a high bandwidth channel, including, but not limited to, coaxial cable, ADSL or CAT5 telephone line connection. The Portal (304) may also receive digital audio content from other means such as terrestrial radio broadcasts.

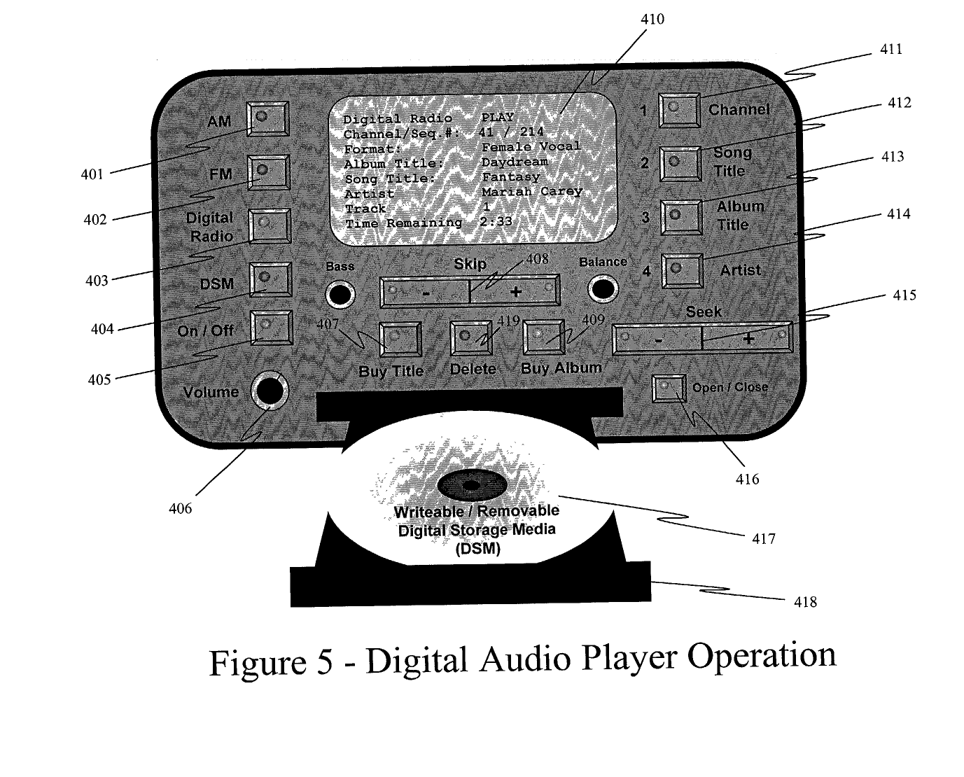

FIG. 5 illustrates the Digital Audio Player console & operation. The Player is a multi-function device that operates as a conventional AM/FM radio, Digital Radio, or a player of removable digital storage media (DSM). Such removable DSM may include CDs and DVDs, but is not limited to these formats. The mode of operation is selected by depressing any of the top four buttons (401 to 404) on the left-hand side of the console. AM/FM Radio Mode (401, 402). When operating as an AM or FM radio, the digital display (410) provides a readout of the mode of operation and the station selected. The skip control (408) functions as the tuner, moving the radio dial to the next position forward (+) or backward (−) in the radio spectrum. The seek control (415) skips to the next station (+) or previous station (−). The top four buttons (411 to 414) on the right-hand side of the console function as radio memory buttons, returning to preprogrammed stations. Stations are programmed by selecting a radio band (AM or FM), tuning in a station, and depressing the button for 5 seconds. Digital Radio Mode (403). When Operating in Digital Radio mode, the device functions as a hybrid between a radio and a CD player. In this mode the Player is capable of accessing all audio tracks stored within the Player's fixed internal memory.

The example of FIG. 5 illustrates the device working in Digital Radio mode. The console provides a digital readout of each track as it plays. The digital display (410) includes: the number of the entertainment channel from which the track originates (if applicable); the order of play on that channel (if applicable); music format or category (rock, pop, jazz, etc.); title of the track's album; the title of the track; name of artist; album track number; and the length of play time remaining on track. An important feature of Digital Radio mode is that it gives the listener complete control over the order in which audio tracks are played, via the top four buttons on the right hand side of the console (411 to 414) and the Seek control (415). The listener is able to play all audio tracks stored within the Radio as a pre-sequenced mix by channel, based on entertainment or music classification, by depressing the Channel button (411). The Seek control (415) skips to the next available music channel (bypassing channels that have no content). The Skip control (408) skips to the next (+) or previous (−) track in the pre-recorded mix. If the skip control isn't pressed, the tracks play in the sequence scheduled in the pre-mix. The listener is able to play all tracks stored within the Player in alphabetical order of track title by depressing the Track Title button (412). This feature makes it easy to locate any particular audio track. The Seek control (415) provides multi track ascending (+) or descending (−) skipping for fast searching. The Skip control (408) provides single track ascending (+) or descending (−) skipping for slow searching. If the skip control isn't pressed, the tracks play in alphabetically ascending name order. The listener is able to play all audio tracks stored within the Player in alphabetical order of album title by depressing the Album Title button (413). Complete albums are downloaded only by specific request, as described in the section under FIG. 3. In cases where specific albums have been downloaded, the tracks will play in the order they appear on the album. The Skip control (408) provides single track ascending (+) or descending (−) within a particular album. The Seek control (415) skips to the next (+) or previous (−) album.

The listener is able to play all tracks stored within the Radio in alphabetical order of artist name by depressing the Artist button (414). The Skip control (408) provides single track ascending (+) or descending (−) within a particular artist's tracks. The Seek control (415) skips to the next (+) or previous (−) artist. The listener may purchase any particular track while it is playing, by depressing the Buy Title button (407). Pressing this button sets a flag in the internally stored music database, indicating that a purchased request has been made. The purchase request is not finalized until the Digital Audio Player completes the payment transaction or receives authorization via the Digital Audio Distribution Hub (102). This occurs automatically once the Digital Audio Player (310, 313) communicates with the Digital Portal (304) and data is exchanged between the two devices. Once the transaction is complete, an updated music or audio track data file is set which allows the track to be copied (once) to a DSM (417). The user may do this at any time, once a writeable DSM has been placed in the disk tray (418) and inserted in to the Radio by pressing the Open/Close button (416). At such time, the system copies both the music or audio track file and database information to the writeable DSM and erases its internal copy. The accompanying database information allows multiple tracks on the DSM to be automatically catalogued for easy reference and play access.

In cases where the Buy Album button (409) button is pressed, a sequence similar to the above occurs. If the album has been already downloaded as a demo by request, then the purchase of all album tracks becomes immediate. If not, then the Player requests the entire album from the Digital Audio Portal (118), which in turn requests it from the Digital Music Data and Billing Hub (102), once the payment transaction has been completed. Upon receipt of the required files, the Player prompts the user to write a permanent copy to the DSM (417). When the delete button (419) is pressed while a particular track is being played, the Player updates its internal music database by setting the delete flag for the current track, and moves to the next track (in accordance with current settings). Once a track is deleted, the Player immediately makes the track inaccessible and unplayable. Furthermore, the Player transmits deleted track information back to the Digital Audio Portal and to the Digital Audio Distribution Hub (102), which causes the particular track to be filtered out from any future pre-mixed music channel downloads to the Player. This continues unless and until the track is specifically un-deleted by the subscriber via the music selection web site.

When Operating in DSM mode, the device functions as CD or DVD player, by accessing permanently recorded music from digital storage media (417) inserted in the tray (418), such as a CD or DVD disks. Where a Digital Audio Player has recorded the DSM content, the music is accessed in the same fashion as Digital Radio Mode, making full use of the built in audio track database. In DSM mode, the Buy Title (407), Buy Album (409) and Delete (419) buttons are no longer applicable. A single Digital Audio Player 124 may serve the tastes of multiple subscribers. Specifically, when the Player 124 is off and the On/Off button (405) is depressed, the user is prompted for a pass phrase, which is entered via the radio button keys (411 to 414). The user's pass phrase is used to recover the run time encryption keys unique to each user or subscriber. These keys are used to: 1) access specific records and fields within the onboard database; 2) create digital certificates; 3) digitally sign and encrypt Purchase Orders and other requests; and 4) decrypt digital audio tracks. The user code identifies the subscriber and allows the Player to access one of potentially several distinct music and audio track libraries. This feature allows different users to access the tracks of their choice. A 16 GB internal hard drive, for example, would allow the Player to store 200 hours of MP3 encoded music for each of two different subscribers.

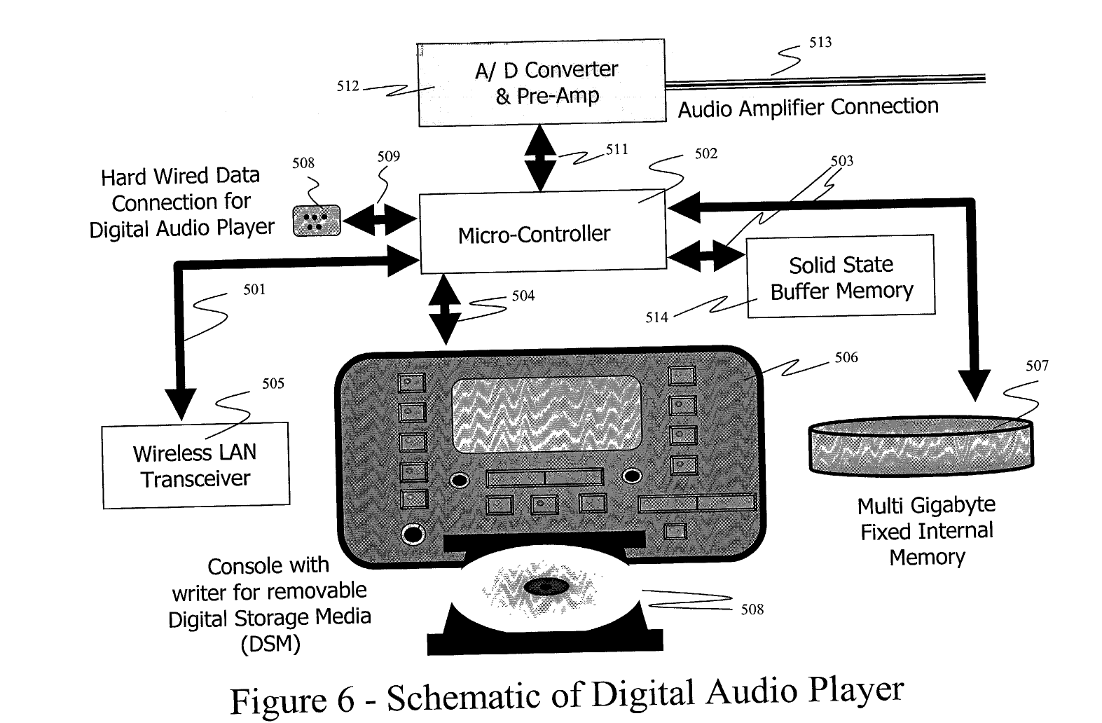

FIG. 6 illustrates one embodiment of the Digital Audio Player 124 of FIG. 2. The player 124 corresponds to a personal computer equipped with multi-gigabyte fixed internal memory (507), a removable digital storage media reader and writer (508), a Wireless Local Area Network (WLAN) Interface (505) and a specialized hardware control console (506). The Micro-controller (502) at the heart of the Player comprises a microprocessor (Pentium 150 MHz class or above) and solid state memory. The device may include an additional solid state buffer memory (514), to prevent jitter and skipping while playing audio tracks, in cases where the multi-gigabyte fixed internal memory is an electromechanical device (such as a magnetic hard disk drive). The Player provides an optional hard wired data connection (508), which may utilized to plug the Player directly into the Portal, for various applications, including one in which the user wants to integrate the Portal (304) and Player (313) within a home entertainment system (303). The above components are connected via data busses 501, 503, 504, 509 and 511.

In one embodiment, the multi-gigabyte fixed internal memory (507) consists of solid state memory, however, it may also employ a magnetic hard drive. In either case, in an embodiment, data storage capacity exceeds 10 GB. The WLAN Interface (505) consists of a bi-directional radio transceiver operating in accordance with a recognized high bandwidth wireless LAN standard such as IEEE 802.11b. Each Player contains a unique hard-wired identification number keyed to its companion Portal. In an alternative embodiment, the digital audio player 124 could also be integrated as a sub-system of a vehicle's overall in-dash computer system which might control such vehicle functions as navigation, entertainment, diagnostics, communications and vehicle operations. In this embodiment, the digital audio player's function is achieved through multi-tasking software programs, with the control console represented through a touch screen based graphical user interface or other software programmable keys or controls. This embodiment permits the digital audio player to take advantage of some or all of the components necessary for on-board computer processing already provided in current vehicles or as such components become available in the future. Such configuration may require the addition of a reading and writing device for a removable DSM as well as additional internal memory storage.

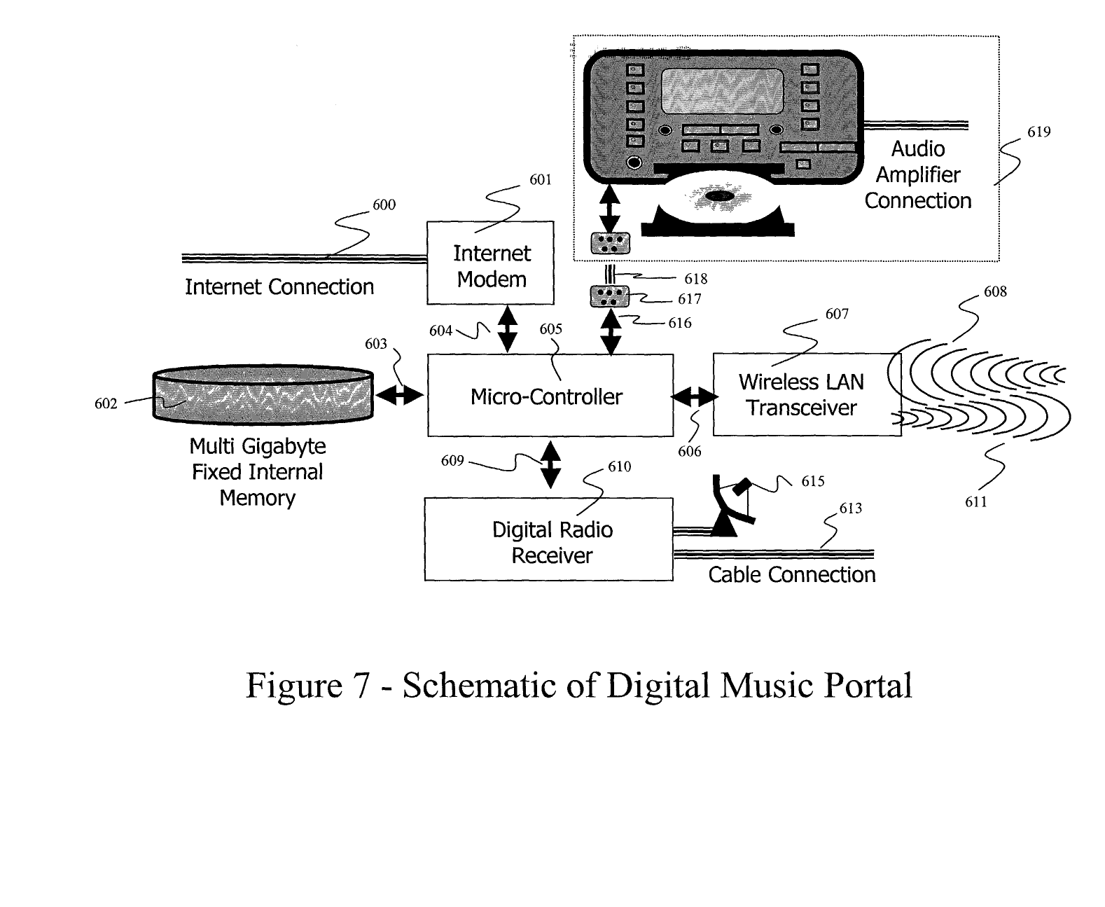

FIG. 7 illustrates one embodiment of the Digital Audio Portal 118, which corresponds to a personal computer equipped with multi-gigabyte online data storage (602), a Wireless Local Area Network (WLAN) Interface (607), an Internet Modem (601) and a Digital Radio Receiver (610). The Micro-controller (605) at the heart of the Portal comprises a microprocessor (Pentium 150 MHz class or above) and solid state memory. The Multi-Gigabyte Online Data Storage (602) is comprised of a magnetic hard drive or, alternatively, a solid-state memory device, preferably having a capacity in excess of 10 GB. The WLAN Interface (607) consists of a bidirectional radio transceiver operating in accordance with a recognized high bandwidth wireless LAN standard such as IEEE 802.11b. The Modem (601), in an embodiment, provides a high bandwidth Internet channel, including, but not limited to, coaxial cable, ADSL or CAT5 telephone line connection.

The Digital Radio Receiver (610) receives digital audio inputs from various signal sources including cable (613) and satellite (615), but may include other sources including terrestrial broadcasts. The Portal 118 provides an optional data connection (617), which may be utilized to hard wire (618) the Player (619) directly into the Portal, for various applications, including one in which the user wants to integrate the Portal (304) and Player (313) within a home entertainment system (303). The above components are connected via data busses 603, 604, 606, 609, 616 and 606. Each Portal 118 contains a unique hard-wired identification number keyed to its companion Player 124.

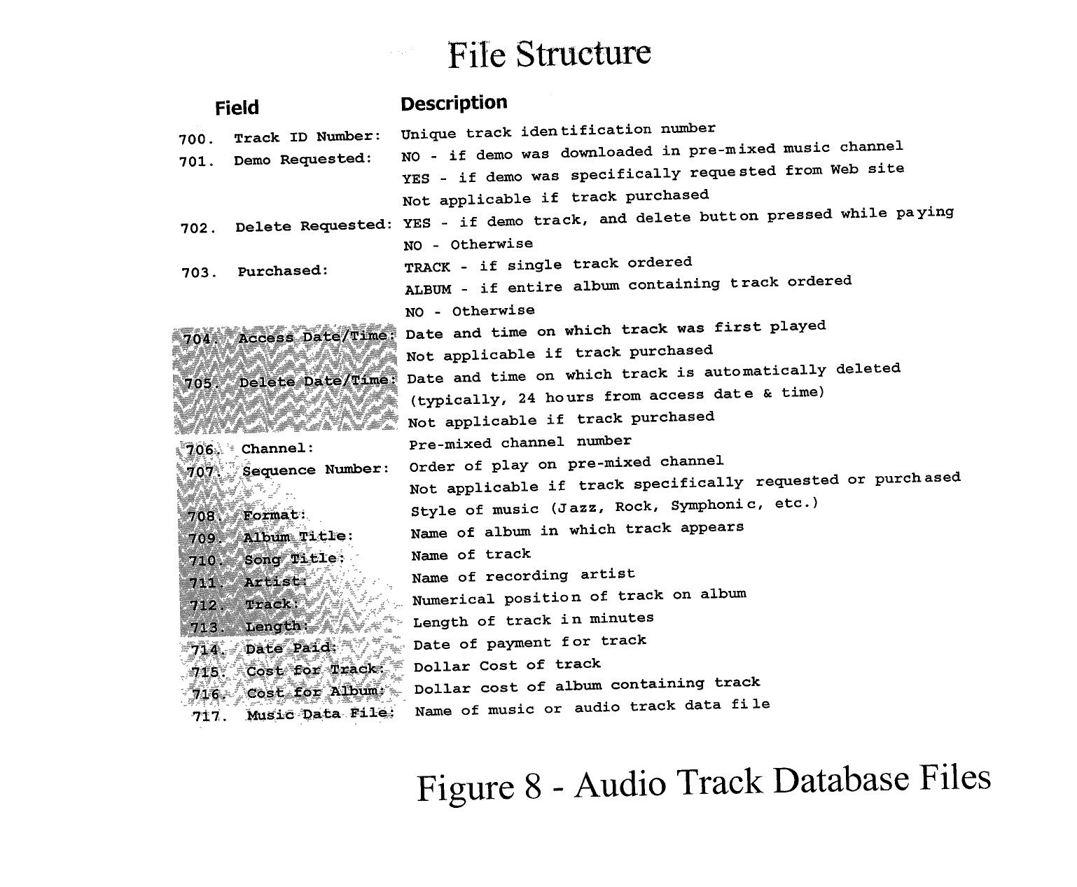

FIG. 8 is a diagram illustrating one embodiment of an encrypted database record and various fields of the record, which is downloaded along with each selected audio file from the digital audio distribution hub 102 to the digital audio portal 118 and then to the digital audio player 124, all of which are shown in FIG. 2. Each audio track downloaded from the Digital Audio Distribution Hub (102) to the Digital Audio Portal (118) and then to the Digital Audio Player (121), is accompanied by an encrypted database record containing the fields and information listed in FIG. 8. Each music track is referenced, system wide, by a unique identification number. The database record associated with each track contains a field containing its unique identification number (700), along with descriptive information (706-713). The descriptive information is displayed by the Player's digital readout (410) whenever the track is accessed, and is also used by the Player to locate and schedule the play order of tracks by channel, music or audio entertainment format, title, album title or artist.

When the Player first “opens” a particular track (defined as either: playing the track; deleting the track; or purchasing the track), two things happen. The Access Date & Time field (704) of the record associated with that track is stamped with the date and time of such opening and a digital certificate with fixed expiry is produced and stored. The Delete Date & Time is automatically set equal to the Access Date & Time plus a system defined demonstration period (typically 24 hours). Periodically, the system scans its database and flags all database records where the Delete Requested field (702) is set to YES, or the certificate has expired. Such flagged records, and their associated music data file (719) are deleted by the Player. If the Demo Requested field (701) is set to YES or the Delete Requested field (702) is set to YES, then the Player copies the first 4 fields (700-703) of the record to the Listener Preference File, prior to deleting the record.

If the Buy Title button (407) or the Buy Album (409) button is pressed while a track is playing, then the Player accesses the database record associated with the track, and displays on the Player's screen (410) the cost for the track (715) and the cost for the associated album (716). If the user confirms the purchase after seeing the cost data, the Player performs the following operations. It sets the Purchased field (703) to TRACK or ALBUM (as the case may be), and it copies the first 4 fields (700-703) of the database record to the Listener Preference File. If the Purchased field (703) has been set to ALBUM, then the player checks to see if the entire album has been downloaded into the Player for demo. If it has, the Player performs the same two operations listed above for each track of the album. Non-repudiation of the purchase is achieved by prompting the subscriber for an additional pass phrase, which is used to recover the Purchase signing key from the subscriber's private key chain. The Purchase signing key is used to sign the XML Purchase Order, which is then stored and then forwarded to a Digital Audio Distribution Hub (102) for further execution.

Once the Player (121) and Portal (118) establish communications (119, 120), the Player (121) uploads all records in its Listener Preference File to the Portal (118). Upon completion, the Player (121) clears from its memory of all Listener Preference File records that it has just uploaded. The Portal (118), in turn, uploads all received Music Preference File records to the Digital Audio Distribution Hub (102), via the Internet connections (117, 110). Upon completion, the Portal (118) clears from its memory all Listener Preference File records that it has just uploaded.

The Digital Audio Distribution Hub (102) consists of one or multiple distributed computer facilities specifically established in connection with the Digital Audio Distribution System disclosed herein. These Hubs (102) are mirrored to increase performance, scalability and robustness under a variety of network failures. For example, if one hub is unavailable, due to either network congestion or failure, the Portal (118) automatically selects a secondary site with which to exchange its data.

The Digital Audio Distribution Hub (102) scans the records in the Listener Preference File to find those records in which the Purchased field (703) has been set to TRACK or ALBUM. It bills the subscriber's account (104) for the purchased audio tracks, creates and signs a new database record for each purchased track, stamps the Date Paid Field (715) with the current date and time; and prepares digitally watermarked music data file. The music data file is specifically encoded to allow the Player to make a single copy to a digital storage media (DSM). The Digital Audio Distribution Hub (102) then downloads all new database records and associated digital music and audio track data files to the Portal (118). Upon completing the purchase transactions in the above manner, the Digital Audio Distribution Hub (102) appends all records in the recently uploaded Listener Preference File to the subscriber's existing Listener Preference File.

Utilizing the Listener Preference File to Create a Selection Filter for the Portal. From time to time, the Digital Audio Distribution Hub (102) collectively analyzes Music Preference File data for all subscribers, utilizing techniques such as automated collaborative filtering. Automated collaborative filtering, originally developed at the MIT media lab, is based on the simple notion that people who like the same things as each other are likely to provide good recommendations to one another. When applied in connection with the systems and methods disclosed herein, collaborative filtering analyzes each user's listener preference file, which contains data on purchases, likes and dislikes, for the purpose of establishing groups of people who have similar tastes in music. Once a subscriber is placed within a group, the system makes recommendations based on what music and audio tracks the members of that group are requesting and buying. Over time, as the size of the group and the number of entries in the Listener Preference Files increases, recommendations become more accurate.

On the basis of such analysis, coupled with a user's choices and weighting of pre-mixed music channels (e.g. from the Web site), the system constructs music selection filters for each subscriber, which are downloaded to the Portals (118). The filters consist of the number of hours of content requested from each pre-mixed entertainment channel together with two lists of Track ID numbers (700). One list contains audio track likes, and the other list contains track dislikes. The Portal (118) uses these pre-mixed channel requests and Track ID lists to filter digital audio entertainment streams from the pre-mixed channels. The Portal (118) preferentially stores music and audio tracks that appear on the “likes” list. Likewise, it rarely or never stores music or audio tracks appearing on the “dislikes” list.

Once the Portal (118) has received the new database records and associated digital music and audio track data files from the Digital Audio Distribution Hub (102), it transmits the new information to the Player (121). For each new database record it receives, the Player (121) checks the unique track ID number to see if it already has a database record of that track on file. If so, it deletes the music or audio track data file associated with the existing database record, downloads the new music database file and replaces the existing database record with the new record. In this way, the Player (121) replaces demo tracks with purchased tracks. Database records are encrypted with each unique subscriber's key so as to maintain separation among multiple users using the same Player.

Because the Digital Music Data & Billing Center (102) sends a new audio track data file, each time a track is ordered, the purchased music may be, optionally, delivered in a less compressed, higher quality format when compared to the demo format (MP3 encoding for example). This allows the Player to write high quality digital music files to DSMs. To improve communication channel efficiency this higher quality format may be compressed prior to download and decompressed after the transmission by utilizing otherwise idle CPU time in both the Digital Portal and the Digital Player. From time to time, the Hub (102), via the Internet connections (110, 111) supplies recording production companies (111) with statistical and or other information related to the collective music purchases and tastes of listeners, which can be analyzed demographically to rapidly identify and target emerging music trends and markets.

It is to be understood that even though various embodiments and advantages of the present invention have been set forth in the foregoing description, the above disclosure is illustrative only, and changes may be made in detail, and yet remain within the broad principles of the invention. For example, many of the components described above may be implemented using either digital or analog circuitry, or a combination of both, and also, where appropriate, may be realized through software executing on suitable processing circuitry. Therefore, the present invention is to be limited only by the appended claims.

1. A method of distributing digital content files to a user's content storage device over a computer network, the method comprising:
identifying content files to be distributed to the user;
encoding demonstration versions of the identified content files, the encoding including an identification parameter associated with the user's content storage device, and each demonstration version further including demonstration parameters and purchase or rental pricing information;
transferring the encoded demonstration versions of the content files to the user's content storage device;
in response to the user selecting a transferred encoded demonstration version of a respective content file by utilizing a player that is contained in or coupled to the content storage device,
examining the identification parameter to determine whether access to the selected encoded content file is unexpired, and
when access is unexpired, decoding the content file for use and review by the user and displaying purchase pricing or rental information;
while the content of the file is being accessed via the player, determining whether the user has selected for purchase or rental, rejected, or not selected the corresponding content file;
in response to the respective selections for purchase or rental user determinations for the content files, providing the user temporary access to the decoded selected files; and
upon verifying charge to the user, providing the content storage device unlimited access in the case of purchase and limited access in the case of rental to the content files using the player.

2. The method of claim 1 wherein identifying comprises providing a Web site including a collection of content files, and identifying selected content files in response to user requests supplied to the Web site.

3. The method of claim 1 wherein each demonstration version comprises an encoded version of the corresponding content file, which is encoded to play on only a specific content storage device or devices.

4. The method of claim 1 wherein providing the user unlimited access to the purchased decoded files and limited access to rented files includes deleting rejected or expired demonstration content files previously transferred to the user.

5. The method of claim 1 wherein providing the user temporary access to the decoded selected files comprises providing the user access to the files for a specified demonstration time, and if the billing confirmation of the user is not verified within the demonstration time, disabling user access to the selected files.

6. The method of claim 1 wherein providing the user temporary access to the decoded selected files comprises providing the user access to the files for a specified number of plays and if the billing confirmation of the user is not verified within the demonstration time, disabling user access to the selected files.

7. The method of claim 1 wherein encoding demonstration versions of the identified content comprises encrypting the content files, the encrypted files having an associated encryption key having a value that is a function of the identification parameter associated with the user.

8. The method of claim 1 wherein at least some of the content files comprise digital audio, video, navigational, and text files.

9. The method of claim 1 wherein transferring the encoded demonstration versions of the content files to the user's content storage device comprises storing the encoded demonstration versions of the identified content files in a queue at a network server, and transferring the files from the queue to the user's content storage device in response to a user action.

10. The method of claim 9 wherein the user action comprises the user connecting a user content device to a computer network either physically or wirelessly.

11. The method of claim 1 wherein charging for the content file identified for purchase or rental is done in response to a user action.

12. The method of claim 11 wherein the user action comprises the user connecting a user content device to a computer network either physically or wirelessly.

13. The method of claim 1 wherein identifying content files to be distributed to the user comprises gathering a number of user profile parameters from the user, generating a user content profile from the gathered profile parameters, the user profile identifying content the user is expected to select, and thereafter identifying content files by using the user profile.

14. The method of claim 13 wherein user profile is determined at least in part on the user's selection for purchase, rental, or deletion of content files.

15. A method of distributing digital content files to a user's content storage device over a computer network, the method comprising:
identifying content files to be distributed to the user;
encoding demonstration versions of the identified content files, the encoding including an identification parameter associated with a user's fixed and a user's mobile content storage device, and each demonstration version further including demonstration parameters and purchase or rental pricing information;
transferring the encoded demonstration versions of the content files to the user's fixed content storage device;
transferring the encoded demonstration versions of the content files from the user's fixed content storage device to the user's mobile content storage device;
in response to the user selecting a transferred encoded demonstration version of a respective content file by utilizing a player that is contained in or coupled to the content storage device,
examining the identification parameter to determine whether access to the selected encoded content file is unexpired, and
when access is unexpired, decoding the content file for use and review by the user and displaying purchase pricing or rental information;
while the content of the file is being accessed via the player, determining whether the user has selected for purchase or rental, rejected, or not selected the corresponding content file;
in response to the respective selections for purchase or rental user determinations for the content files, providing the user temporary access to the decoded selected files; and
upon verifying charge to the user, providing the content storage device unlimited access in the case of purchase and limited access in the case of rental to the content files using the player.

16. The method of claim 15 wherein identifying comprises providing a Web site including a collection of content files, and identifying selected content files in response to user requests supplied to the Web site.

17. The method of claim 15 wherein each demonstration version comprises an encoded version of the corresponding content file, which is encoded to play on only a specific content storage device or devices.

18. The method of claim 15 wherein providing the user unlimited access to the purchased decoded files and limited access to rented files includes deleting rejected or expired demonstration content files previously transferred to the user.

19. The method of claim 15 wherein providing the user temporary access to the decoded selected files comprises providing the user access to the files for a specified demonstration time, and if the billing confirmation of the user is not verified within the demonstration time, disabling user access to the selected files.

20. The method of claim 15 wherein providing the user temporary access to the decoded selected files comprises providing the user access to the files for a specified number of plays and if the billing confirmation of the user is not verified within the demonstration time, disabling user access to the selected files.

21. The method of claim 15 wherein encoding demonstration versions of the identified content comprises encrypting the content files, the encrypted files having an associated encryption key having a value that is a function of the identification parameter associated with the user.

22. The method of claim 15 wherein at least some of the content files comprise digital audio, video, navigational, and text files.

23. The method of claim 15 wherein transferring the encoded demonstration versions of the content files to the user's mobile content storage device comprises storing the encoded demonstration versions of the identified content files in a queue at a network server or servers, and transferring the files from the queue to the user's mobile content storage device via the user's fixed content storage device in response to a user action.

24. The method of claim 23 wherein the user action comprises the user establishing a wireless link between the content access device, which contains the mobile content storage device, and a content loading device, which contains the fixed content storage device.

25. The method of claim 15 wherein charging for the content file identified for purchase or rental is done in response to a user action.

26. The method of claim 25 wherein the user action comprises the user establishing a wireless link between the content access device, which contains the mobile content storage device, and a content distribution server via the a content loading device, which contains the fixed content storage device.

27. The method of claim 15 wherein identifying content files to be distributed to the user comprises gathering a number of user profile parameters from the user, generating a user content profile from the gathered profile parameters, the user profile identifying content the user is expected to select, and thereafter identifying content files by using the user profile.

28. The method of claim 27 wherein user profile is determined at least in part on the user's selection for purchase, rental, or deletion of content files.

29. A computer system for distributing digital content files to users, the system comprising:
a content distribution server including a plurality of digital content files and a user interface component, the user interface component operable in a first mode to receive user requests and select corresponding content files in response to the user requests, to encode the selected content files using an identification parameter associated with a corresponding user content storage device, each demonstration version further including demonstration parameters and purchase or rental pricing information, and to provide the selected content files in response to a content request, the server operable in a second mode to receive purchase and rental requests and to bill the user for the corresponding content files, and when the user is successfully billed to provide decoded content files for each purchased file and encoded content files corresponding to each rental request, and also to receive user profile information and update a user profile on the server responsive to the received user profile information;
a content loading system coupled to the content distribution server, the content loading system operable in a first mode to provide user requests to the server to select corresponding demonstration content files and to receive corresponding encoded demonstration content files, and operable in a second mode to provide purchase and rental requests to the server responsive to user selection inputs, to receive decoded content files for each purchased file and encoded content files for each rental request, and to provide user profile information to the server; and
a content storage device coupled to the content loading system to receive the encoded selected content files, the content storage device being adapted to be coupled to a content access system for accessing a particular encoded demonstration content file stored on the content storage device in response to a user request applied to the content access system, the content storage device decoding the corresponding demonstration content file to provide the user temporary access to the content file when the associated demonstration parameters indicate the content file has not expired, such access including decoding the demonstration version of the file for use and review and displaying purchase price or rental price information, and the content storage device being adapted to receive user purchase, rental, and rejection requests from the content access system while the file is being accessed and to provide temporary access to the file responsive to purchase and rental requests, and the content storage device providing purchase and rental requests to the content loading device along with user profile information and receiving decoded content files for each purchased file and encoded content files for each rented file.

30. The system of claim 29 wherein the content files comprise digital audio, video, navigational, and text files.

31. The system of claim 29 wherein the content loading system comprises a commercial network content loading system.

32. The system of claim 29 wherein the content loading system comprises a consumer content loading system further including a content storage queue for storing content files being transferred from the content distribution server and then transferring the content files to the content storage device responsive to a user action.

33. The system of claim 32 wherein the user action comprises the user coupling the content access system to the content loading system.

34. The system of claim 33 wherein the coupling comprises wireless coupling when the access system is proximate the content loading system.

35. The system of claim 29 wherein the content storage device comprises a portable content storage device that is physically either coupled to the content loading device or the content access system.

36. The system of claim 29 further including a content access system installed in a vehicle to provide occupants of the vehicle with access to digital content files.
